(19) United States
(12) Patent Application Publication
(10) Pub. No.: US 2025/0353971 A1
(43) Pub. Date: Nov. 20, 2025

(54) Method for producing reactive biomass and products thereof

(71) Applicant: Luonnonvarakeskus, Helsinki (FI)

(72) Inventors: Veli Hietaniemi, Sastamala (FI); Ossi Pastinen, Kantvik (FI); Ilkka Lehtomäki, Helsinki (FI); Olavi Myllymäki, Espoo (FI)

(21) Appl. No.: 18/873,358

(22) PCT Filed: Jun. 27, 2023
(86) PCT No.: PCT/FI2023/050388

§ 371 Date: Dec. 10, 2024

(30) Foreign Application Priority Data
Jun. 28, 2022 (FI) 20225587

(51) Int. Cl. C08H 8/00; C05C 9/00; C05F 11/00; C08H 7/00; C08L 97/02

(52) U.S. Cl. CPC C08H 8/00; C05C 9/00; C05F 11/00; C08H 6/00; C08L 97/02

(57) ABSTRACT

According to an example aspect of the present invention, there is provided a method for converting a plant material to a hardenable biomass by means of a reactive extrusion in a series of extrusion modules, which exposes carbohydrate compounds of the plant material.

### FIELD

The present invention relates to a method, which produces recyclable and biodegradable solid biocomposite objects and moist materials from plant materials that are wholly included in the biocomposite without separation of components from the plant in advance.

### BACKGROUND

Amine derivatisation in extrusion is described in patent FI129257. Cellulose, its derivatives and its mixtures forms amides with an amine reagent. It is a chemical condensation reaction. Condensation reaction requires that excess of water is taken away, which happens in drying. After the reaction, the carbohydrate-amide compound solidifies, and all the components are in the same structure. Thus, no separation of components such as cellulose or lignin are required. This is advantageous, because separation of such components requires much energy, water, and many machines, and it is time-consuming. Amine derivatisation neither requires any oil-based non-renewable material. Final biocomposite can contain over 80% of the original plant material. As a result, this type of biocomposite production is outstanding.

Amine derivatisation with urea requires that temperature is below 130° C., which temperature is too low that the carbohydrates can be efficiently exposed in a normal extrusion. Amine reaction also requires that carbohydrate is efficiently acidified. High acidification harms extrusion. As a result, amine derivatisation does not produce strong structures, as presented in patent application FI20185627.

Normal twin-screw extruder mixes the mass in the screws, which are in cylinders that can be heated and cooled. In the reaction zone the mass is transferred through reverse screws, where the pressure is high. In the end, the mass is pushed through nozzles into ambient conditions. Twin-screw extruders are used to compound the biomaterial and other components. The final biocomposite is moulded and dried in the downstream processes after extruder.

Extrusion that is applied into amine derivatisation is described in patent application FI20185627. Twin-screw extruders have only one reaction zone, which is not the most efficient in shearing plant materials. It is difficult to keep high temperatures and high pressure in a twin-screw extruder. Furthermore, twin-screw extruders require many pre- and downstream processes, which makes the process complicated and restricted. For example, efficient pre-milling of plant material is required.

There is thus a need for a novel method of producing recyclable and biodegradable solid biocomposite objects and moist materials from plant materials that are wholly included in the biocomposite without separation of any components from the plant in advance.

### SUMMARY OF THE INVENTION

The invention is defined by the features of the independent claims. Some specific embodiments are defined in the dependent claims.

According to an aspect of the present invention, there is provided a method for converting a plant material to a hardenable biomass by means of reactive extrusion comprising series of extruder modules.

This and other aspects, together with the advantages thereof over known solutions are achieved by the present invention, as hereinafter described and claimed.

The method of the present invention is mainly characterized by what is stated in the characterizing part of claim 1.

Considerable advantages are obtained by means of the invention. In the present context, reactive extrusion is composed from several unit operations, in where conditions can be controlled according to physical and reaction requirements. Planetary Roller Extrusion (PRE) is a mechanical option for a reactive extrusion. In reactive extrusion, modules of PRE act as successive reaction zones, which have different conditions. The reactive flow is solid, because PRE does not require extra water for material transport. In spite of the solid material, PRE has good heat transfer, shearing, mixing and milling abilities. In addition, the present method uses renewable raw materials, little energy, small amount of water and small number of machines. The obtained products are recyclable and biodegradable. Thus, there is no harm to the nature, when the product is recycled back into the nature. Furthermore, effective breaking of carbohydrate polymers to monosaccharides will not take place in the production of reactive biomass with the present multiscrew extruder. Thus, the monosaccharides are not exposed to harsh extrusion conditions such as e.g. to high temperature. This phenomenon decreases formation of harmful chemicals such as furfural and hydroxymethylfurfural.

Next, the present technology is described more closely with reference to certain embodiments.

### EMBODIMENTS

The present technology provides a method, which produces recyclable and biodegradable solid biocomposite objects and moist materials. They are produced from plant materials that are wholly included in the biocomposite without separation of any components from the plant in advance. Raw materials can be for example straw, hay, leaves, hulls and other side products of grain mills. Raw materials can also be selected from shredded cardboard, paper, saw dust, shredded cotton clothes etc. The dry bio-objects can be drilled, polished, glued and painted. The wet material works as biological glue (bio glue). They can also act as fertilisers and soil improvers.

In the present context, the following definitions apply:
Reactive biomass: Reactive extrusion produces reactive biomass that solidifies during drying or produces for example moist bio glue and fertilisers. Acids may be required to add to the mass before drying. More precisely, reactive biomass is wet, reactive and mouldable fibrous mass, which is produced in a multi-screw extruder with possible plasticizing renewable substances. All components of the blend are naturally degradable natural polymers and do not contain petroleum-based or fossil ingredients. When renewable urea or lignin is mixed into the reactive biomass and the mixture is dried, irreversible hard chemical structures are formed. Reactive biomass is reactive because the ingredients of the pulp, hemicellulose, cellulose, and lignin, as well as added plasticizers, participate in the reactions of urea or lignin.
Solidification: The reactive carbohydrates will solidify due to chemical reactions, when it is dried. Solidification will co-solidify all the components of the mass. The produced material will not easily break in water.
Solid bioproduct object: Solid bioproduct object can be drilled, polished, glued and painted.
Recyclability: The material can be milled and reused in the process. Burning that frees carbon dioxide, is avoided.
Biodegradability: The materials are biodegradable due to their hydrolysis caused by cellulase. Starch is easily hydrolysed in nature. Lignin will act as a natural lignin. Polyvinyl alcohol, if required, breaks gradually in nature.

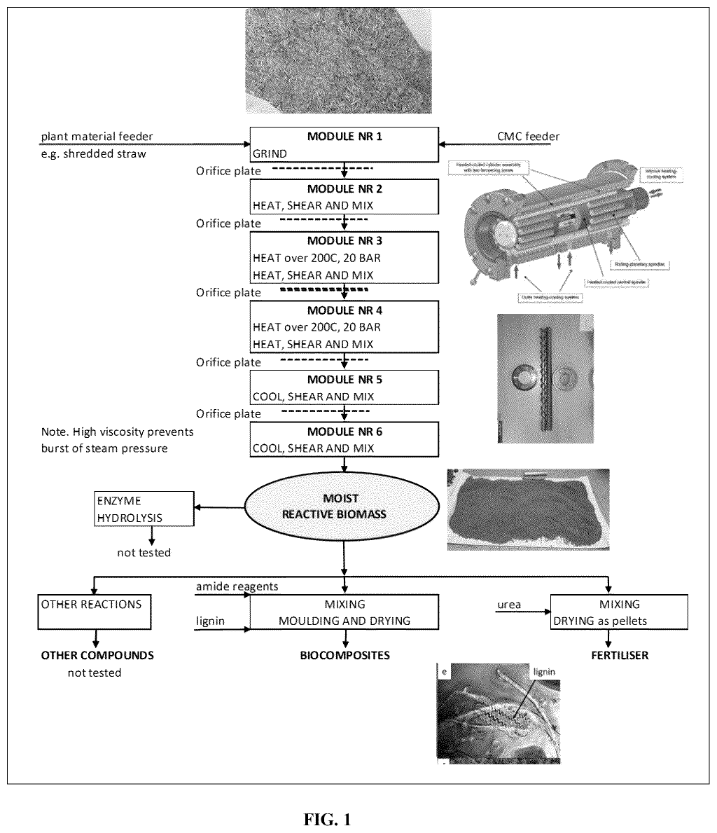

FIG. 1 is a flow chart describing the unit operations of the present method.

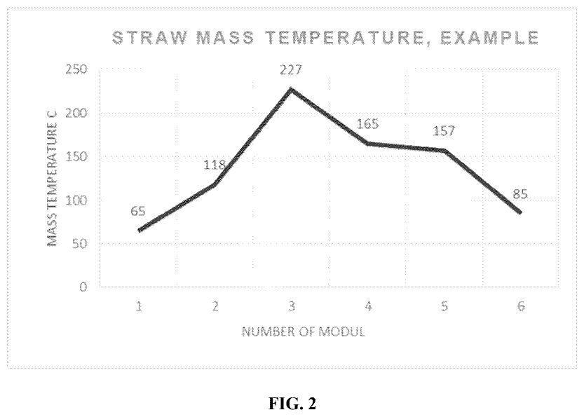

FIG. 2 is a graph showing straw mass temperature profiles vs. number of extruder modules.

The present method is based on that the carbohydrate compound of plant materials is exposed in a reactive extrusion. Thus, it works as an active ingredient in a biocomposite. If necessary, the carbohydrate can be acidified. All the main unit operations and reactions are carried out in one planetary roller extruder (PRE), and the final moulding and drying is carried out in downstream processes.

Dry fibers, possibly containing starch, water and for example renewable CMC, are added to the multi-screw extruder. CMC and starch make the biomass plastic and later participate in the chemical reactions of the reactive biomass during drying. The plastic biomass allows for easy propagation and high vapor pressure in the multi-screw extruder, which in turn allows for high temperature.

According to one embodiment, the present method for converting a plant material to a hardenable biomass comprises at least the steps of:
providing an aqueous suspension comprising the plant material,
feeding the suspension to a multi-screw extruder comprising several extruder modules in series,
optionally, adding an external carbohydrate to increase the viscosity of the suspension and to improve dough-like behaviour, and
in the extruder modules in series, grinding and/or shearing the suspension in a temperature of at least 150° C. to expose and/or release carbohydrates and lignin of the plant material and obtaining moist and hardenable reactive biomass comprising exposed carbohydrates and lignin.

In the present multi-screw extrusion, the dry fibers are thoroughly wetted. They are ground and mixed under the influence of mechanical forces, heat and pressure. The moisture content of the reactive biomass can be as low as 40%. The fibers can be heated above 200° C., wherein the absolute steam pressure exceeds 16 bars.

Multi-screw extruders are more efficient than twin-screw extruders in grinding, mixing and transferring heat. In addition, multi-screw extruders have more grinding and mixing blades and more effective surface area than typical twin-screw extruders, where part of the screw only acts as a conveyor. In addition, the sequential modules of the multi-screw extruder—in the reactive regions-undergo many repetitive treatments. The modules are separated by interchangeable nozzle plates through which the plant mass is pressed into the next module, which may have different blades and conditions.

In continuous multi-screw extrusion, light airy fibers are compressed into a pile as the pressure increases and the density of the pulp increases. Wet reactive biomass is heavy, which contributes to its reactions and increased capacity. However, the dried reactive biomass product can be light and durable. Under the extruded conditions, a large amount of fiber passes through the continuous extruder, a phenomenon highlighted by the low humidity. The present intensive technology thus provides increased capacities and up-scalability with smaller equipment than disclosed in prior art, which is both surprising and advantageous.

According to one embodiment, the plant material comprises annual and perennial plant materials, such as straw, hay, leaves, side fractions of grain mills, and recycled materials, such as shredded cardboard, paper, saw dust, shredded cotton clothes, shredded straw or oat hulls. In the present method one machine with several successive reaction zones fine mills the feed, heat treat, shear and compound the material with other ingredients even as high as at 60% dry matter.

Reactive extrusion is composed from several unit operations, in where conditions are controlled according to the physical and reaction requirements. Planetary Roller Extrusion (PRE) is a mechanical option for a reactive extrusion. In reactive extrusion, modules of PRE act as successive reaction zones, that have different conditions. The reactive flow is solid, because PRE does not require extra water for material transport. In spite of the solid material, PRE has good heat transfer, shearing, mixing and milling abilities.

According to one embodiment, the multi-screw extruder is a planetary roller extruder (PRE). The PRE produces homogenous mass that forms solid objects after drying. Solidification includes all the components of the feed of PRE. The wet product can act as glue. The solid objects can be drilled, polished and painted. They can also work as fertiliser due to possible nitrogen, potassium and/or phosphorus addition.

PRE can process many raw materials, derived from for example agriculture: straw, husk, mill fractions, food industry: peelings, feathers, chitin, forestry: fibres, lignin, wood, cloth industry: used cloths, bioplastics: packing materials, and several recycled materials.

Physical treatments that can happen in PRE comprise for example efficient milling, efficient heat transfer, efficient mixing and repeatable shearing under high temperature and pressure (hydrothermal treatments) in different conditions.

Chemical reactions that can happen in PRE comprise for example chemical and biochemical hydrolysis, condensation and polymerisation.

PRE can produce products such as biocomposites: objects, packing and construction materials, bio fertilisers: soil improvers with enhanced nitrogen, phosphorus and minerals if required, bioglues and raw materials for efficient enzyme hydrolysis for example to produce monosaccharides that are used in further processes.

In one embodiment, PRE exposes carbohydrates, which are cellulose and uronic acid containing compounds from plant and recycle materials. Exposed carbohydrates react in chemical condensation reactions, which creates water. Such reactions form esters with lignin or amides with amines. Both reactions require that carbohydrates are in an acidic stage. However, the amide reaction requires higher acidification. Condensation reactions require to proceed that excess of water is taken away, which happens in drying. The current invention is based on one PRE machine of several modules that provide many serial reaction zones after which the mass is dried in an external machine.

In one embodiment, PRE uses plant and recycled materials, for example shredded straw, water and extraneous materials like carboxymethylcellulose (CMC), Kraft lignin and urea, all of which take part in the reactions. Other extraneous ingredients are presented in the patent application FI20185627. First PRE modules fine mill the shredded straw. The next modules heat, shear and mix the ingredients in temperature even over 200° C. Fine milling, shearing under high heat and pressure expose the carbohydrates. The last modules cool the solid flow, which is taken out as fine homogenous mass. The extraneous ingredients are added into the appropriate module for example urea requires temperature under 120-130° C.

According to one embodiment, the external carbohydrate is carboxymethyl cellulose (CMC), starch or alginate.

According to a further embodiment, the external reactive carbohydrate such as CMC, starch or alginate is added with feed or after milling the straw. CMC such as other hydrocolloids acts also as viscosity enhancer in the reactive extrusion. It creates a dough even with fine milled straw. The dough provides non-mechanical controllable blockage into the end of reactive extruder. The blockage allows to use temperature over 200° C. in the extruder, which creates high vapor pressure. Without controllable viscous mass, the high vapor pressure will be quickly released from extruder. The release will take with it most of the moisture away, and the extruder will totally block.

According to one embodiment, if addition of acid is required due to the acidification of carbohydrates, the addition is preferably done in the end or after the extruder. Acid will cause high corrosion at high temperature, and some acids will decompose at such conditions.

Patent application FI20185627 discloses amide reaction and twin screw extrusion. The present method provides for example the following novel features compared to what is disclosed in FI20185627: a) reactive extrusion with several successive reaction zones, b) exposing reactive carbohydrates from plant and recycled materials for chemical condensation reactions, c) chemical condensation reaction with lignin that does not require amine, d) CMC, starch or alginate as reactive carbohydrate and as material that generates viscosity, which enables to use high temperature in the reactive extrusion, and e) processing the raw material(s) in one multi-screw equipment providing homogenous biomass that is compressed into a mould.

As a conclusion, solid biocomposite objects and moist materials are produced by two chemical means:

### Ester-Reaction.

Reactive extrusion of plant and recycled material with for example CMC and Kraft lignin, (or polyvinylalcohol).
Put into moulds and dried

### Amide Reaction.

Reactive extrusion of plant and recycled material, CMC and urea that is added under 120-130° C. . . .
Acidification.
Put into moulds and dried

According to one embodiment, the production of monosaccharides from lignocellulose does not need ester or amide reaction. Efficient exposing of reactive cellulose and hemicellulose in PRE for enzyme reactions is the most important feature.

Usually, fibres act only as fillers in biocomposites and they are not chemically bound in biocomposites. In the present method high successive shear and mix at over 150° C. frees part of hemicellulose and cellulose, which take part into the condensation reactions. Hemicellulose of straw is composed from arabinoglucuronxylan (1,6:1:16,6), which dissolves partly in hot water. Glass transition of lignin happens in 150-180° C., which opens part of the lignin that locks the cellulose. Exposing of carbohydrates during extrusion depends on shear, temperature, pressure, concentration of carbohydrate and time. Due to the short extrusion time only part of the carbohydrates can be exposed, which advantageously increases the strength of the final structure.

According to one embodiment, materials that are loose are complicated to extrude at high temperatures due to the high vapor pressure. Loose material will allow steam to burst out from the extruder, which will bring away all free water. The absolute steam pressure of 200° C. is about 16 bars. As a result of that, the extruder will badly block. In the present method CMC will create viscous dough from loose materials and will prevent steam outbreak from the extruder. CMC participates advantageously into the chemical reactions of carbohydrates.

According to one embodiment, the method comprises steps of at least partly filling a mould with said moist and hardenable reactive biomass obtained from the grinding/shearing step and drying said biomass in said mould to produce a solid biocomposite object.

According to one embodiment, the moist and hardenable reactive biomass is mixed with amine reagents or lignin, moulded and dried into a biocomposite.

According to one embodiment, the moist and hardenable reactive biomass is mixed with urea and dried into a fertiliser or part of it.

According to a further embodiment, exposed plant material, CMC, lignin and Kraft lignin are compounded in one PRE without an amine chemical. There is no need for extra acidification, which will corrode PRE. The product of PRE is homogenous mass that is put into moulds. Then the mass is dried, which takes away the excess of water. The reaction proceeds and solid moulded objects or material are formed.

According to one embodiment, exposed plant material, CMC, and amine (added under 120-130° C.) are compounded in one PRE. The product of PRE is homogenous mass that is put into moulds. Then the mass is dried, when the excess of water is taken away. The reaction proceeds and solid moulded objects or materials are formed.

According to one embodiment, reactive biomaterial can be moulded and dried into several solid bioproducts with different structures, such as versatile solid objects for various purposes, packaging materials, construction materials and plant pots. Water resistance of the products can be improved by surface treatments, for example with waxes, paints or coverage of extraneous material. Most of the methods for extending the use paper cups in wet surroundings are applicable.

The dried biocomposites from straw may have low product density, which enlarges its application range to packing aids.

When amine and phosphorous acid are used in the production of reactive biomass, the product can act as a soil improver and fertilizer. Straw is composed of cellulose, hemicellulose, lignin and ash that contains lot of silicates and potassium 2,1-6.8 mg/g. High pH decreases solubility of potassium. One possible composition is presented below:

| | |
|---|---|
| Cellulose | 37% |
| Hemicellulose | 23-30% |
| Lignin | 14% |
| Protein | traces |
| Ash | 5-9% |
| Silicates | 1.5-2% |

When biomaterial is recycled back to field, it increases the level of organic material, which improves the structure, biological activity and water balance of the field. The urea that is compounded in the PRE with the biomaterial enables to decrease washing out the nitrogen in the field.

When surplus nitrogen, potassium and/or phosphorous is mixed into the reactive biomass or with part of it, the dried mixture can be used as a fertilizer, where the nitrogen, potassium and/or phosphorous has extended solubilisation due to the hardened biomass. However, the biomass can be degraded with cellulase enzyme.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### EXAMPLES

### Example 1. Production of Reactive Biomass

a) Preparation of straw: straw is chopped on the field, gathered and milled in an impact mill through 4 mm sieve (see FIG. 1). It is packed to big bags and extruded in a PRE-machine.
b) Running the extrusion with 25 kg/h of straw, 1.25-2.5 kg/h of CMC and 30 kg/h of water at mixing of 120 rpm and temperature of 150-220° C.

### Example 2. Reactions with Kraft Lignin and Urea

c) Running the extrusion with 59 wt-% of straw, 23 wt-% of CMC, 18 wt-% of Kraft lignin and 78 wt-% of water from the total dry matter weight of the suspension.
d) Running the extrusion with 56 wt-% of straw, 22 wt-% of CMC, 17 wt-% of Kraft lignin, 5 wt-% of urea and 70 wt-% of water from the dry matter weight of the suspension.

### Example 3. Raw Materials

e) Replacing straw with cellulose, paper, recycled paper, carton board or saw dust and running the extrusion in the reaction conditions set out in Examples 1 or 2.
f) Replacing Kraft lignin with native lignin and running the extrusion in the reaction conditions set out in Examples 1 or 2, when producing food industry products.
g) Replacing lignin with polyvinyl alcohol and running the extrusion in the reaction conditions set out in Examples 1 or 2, when producing more flexible products.
h) Replacing CMC with starch or alginate and running the extrusion in the reaction conditions set out in Examples 1 or 2.
i) Feeding to the extrusion straw at 79 wt-%, CMC at 16 wt-%, sodium alginate at 5 wt-% and water at 70 wt-% from the dry matter weight of the suspension.
j) Feeding to the extrusion straw at 77 wt-%, CMC at 15 wt-%, sodium alginate at 5 wt-%, urea at 3 wt-% and water at 70 wt-% from the dry matter weight of the suspension.

### Example 4. Production of Reactive Biomass in Empowered Conditions

Preparation of straw: Straw is chopped on the field, gathered and milled in an impact mill through 4 mill sieve (see the FIG. 1.) It is extruded in PRE-machine.
k) Running the extrusion with 25 kg/h of straw, 1.25-2.5 kg/h of CMC and 30 kg/h of water at mixing of 120 rpm.
l) The first and third module had special grinding tools.
m) Temperature profile of the modules is presented in FIG. 2.

### CITATION LIST

### Patent Literature

FI129257
FI20185627

1. A method for converting a plant material to a hardenable biomass, wherein the method comprises at least the steps of:
providing an aqueous suspension comprising the plant material,
feeding the suspension to a multi-screw extruder comprising several extruder modules in series,
optionally, adding an external carbohydrate to the suspension to increase the viscosity of the suspension and to improve dough-like behaviour, and
in the extruder modules in series, grinding and/or shearing the suspension in a temperature of at least 150° C. to expose and/or release carbohydrates and lignin of the plant material and obtaining moist and hardenable reactive biomass comprising exposed carbohydrates and lignin.

2. The method according to claim 1, wherein the plant material comprises annual and perennial plant materials and recycled materials.

3. The method according to claim 1, wherein the multi-screw extruder is a planetary roller extruder (PRE).

4. The method according to claim 1, wherein an external carbohydrate is added, and wherein the external carbohydrate is carboxymethyl cellulose (CMC), starch or alginate.

5. The method according to claim 1, wherein the moist and hardenable reactive biomass is further mixed with amine reagents or lignin, moulded and dried into a biocomposite.

6. The method according to claim 1, wherein the moist and hardenable reactive biomass is further mixed with urea and dried into a fertiliser or part of it.

7. The method according to claim 1, further comprising an acidification stage after the extrusion.

8. The method according to claim 1, further comprising steps of at least partly filling a mould with said moist and hardenable reactive biomass obtained from the grinding/shearing step and drying said biomass in said mould to produce a solid biocomposite object.

9-11. (canceled)

12. The method according to claim 2, wherein the annual and perennial plant materials are selected from the group consisting of straw, hay, leaves, side fractions of grain mills, and combinations thereof.

13. The method according to claim 2, wherein the recycled materials are selected from the group consisting of shredded cardboard, paper, saw dust, shredded cotton clothes, shredded straw, oat hulls, and combinations thereof.

14. The method according to claim 1, wherein the external carbohydrate is added to the suspension.
